(19) United States
(12) Patent Application Publication
(10) Pub. No.: US 2013/0011803 A1
(43) Pub. Date: Jan. 10, 2013

(54) BATCH-WISE OPERATED RETORT USING TEMPORARY STORAGE OF HEAT

(76) Inventor: Roland Siemons, Enschede (NL)

(21) Appl. No.: 13/578,646

(22) PCT Filed: Feb. 14, 2011
(86) PCT No.: PCT/EP11/52132

§ 371 Date: Aug. 13, 2012

(30) Foreign Application Priority Data
Feb. 17, 2010 (EP) 10153811.4

(51) Int. Cl. F27D 21/04; F24H 7/00

(52) U.S. Cl. 432/9; 432/214; 432/32

(57) ABSTRACT

A batch of a substance, e.g., a biomass, is processed in a batch-wise operated retort under the application of heat. The substance releases a combustible process fluid during the processing. The process fluid is combusted for generating heat. The heat is supplied to the retort and/or stored in temporary heat storage in dependence on the progress of the processing for postponed heat supply to the retort.

### FIELD OF THE INVENTION

The invention relates to a processing system for processing a substance, wherein the processing system is configured for processing the substance in subsequent batches. The invention also relates to a method of processing a substance.

### BACKGROUND ART

An industrial retort is used 1) to contain, and 2) to transfer heat to, a substance that is being processed in the retort, 3) to prevent that the substance that is being processed is contacted with foreign matter such as air or another gas and 4) to enable controlled collection of a process fluid, e.g., a reaction vapor or a reaction liquid, that is released by the substance during the processing of the substance in the retort. The substance comprises a compound that is being processed or multiple different compounds that are being processed. The heat is transferred to the substance within the retort. The transferred heat serves to raise the temperature of the substance in the retort to a particular level, at which the desired chemical reactions or physical processes occur. The transferred heat also serves to maintain the temperature at the particular level when the desired processes are endothermic. The substance in the retort is prevented from being exposed to the foreign matter. Exposure to the foreign matter during the processing of the substance might cause the substance to perform undesired chemical reactions such as oxidization at least partly, thereby reducing the yield of the process, or the exposure to the foreign matter might result in contamination of the end-product by undesired compounds. Collection of the process fluid is desirable in order to be able to further utilize the process fluid. For example, collection of the process fluid enables to recover one or more products from the process fluid, e.g., by means of distillation or condensation. Another example is that collection of the process fluid enables to subject the process fluid to combustion.

Heating of the retort from outside may be accomplished in many different ways. The heat is transferred to the substance within the retort via a wall of the retort. Alternatively, the heat may be transferred to the substance in the retort by means of flowing a hot fluid through the retort, thus enabling a direct contact between the substance and the hot fluid. The hot fluid may then be flown through the retort for at least part of the retorting process, for transferring at least part of the required heat to the substance. The hot fluid is then chosen so as to be inert relative to the substance and to the processing of the substance in the retort. The heat is generated through, for example, electrical resistance heating or the combustion of a fuel. The fuel used may comprise at least part of the process fluid released during the processing of the substance in the retort. If there is a sufficient amount of process fluid available at the right moment in time during the processing of the substance in the retort, the use of process fluid contributes to the efficiency of the processing in the sense that additional fuels are not needed for properly operating a retort.

One of the industries employing retorts is charcoal making. Methods for making charcoal, other than through using a retort, include the use of a continuous shaft kiln and the use of a batch-operated kiln. If a kiln is being used, the substance being processed may get into direct contact with oxygen supplied by the ambient air, or by gaseous combustion products. As a result the substance may combust, thus reducing the yield. In case of using a retort, the substance being processed is kept separated from oxygen in the ambient air, and from the gaseous combustion products. Combustion reactions of the substance being processed are thus minimized. For this reason, retorts typically provide higher product yields than kilns. Note, however, that strictly speaking there is usually some oxygen present inside the retort at the start of the process if the air in the retort is not removed before the processing of the substance starts.

A retort can be operated for processing the substance in subsequent batches. The batch-wise operation of a retort can be considered as comprising a sequence of production cycles, one production cycle per batch. Each production cycle can roughly be divided in a heating phase and a production phase. And upon completion of the production phase, the retort is emptied and prepared for receiving the next batch of the substance for the subsequent production cycle. More specifically, for the purpose of explaining the invention discussed in the next section, endothermic phases and exothermic phases are distinguished in the production cycle.

In an endothermic phase, the retort that contains the substance of, initially, the ambient temperature, is heated from outside until favorable processing conditions have been reached inside the retort. During an endothermic phase, the desired physical process or chemical reaction may occur. However, the process or reaction does not yet take place at the desired rate. This phase is called “endothermic”, because at any moment during this phase the retort needs more heat than is being released in the form of chemically bound energy in that part of the process fluid that is intended for combustion. The part of the process fluid that is used for being combusted in order to generate heat for supply to the retort will be referred to as “heating fluid” in the remainder of this text

In an exothermic phase, the substance is processed or reacts at a rate within a desired range, while releasing a combustible process fluid. In so far as required, heating the retort from outside continues so as to maintain the conditions inside the retort under which the substance is processed, or reacts, at the rate within the desired range. This phase is called “exothermic”, because at any moment during this phase the instantaneous heat of combustion of the heating fluid exceeds the retort's immediate heat requirement.

Usually, a heating phase of a retorting cycle is largely endothermic and a production phase is largely exothermic, however, there may occur situations that a heating or production phase is partly endothermic and partly exothermic. The concepts of “endothermic phase” and “exothermic phase” as used in the invention are explained further below.

Consider a batch-wise operated retort that is being heated by combusting the heating fluid. The rate of heat release by the combustion depends on the instantaneous release rate of the heating fluid and on the instantaneous calorific value of the heating fluid. Note that the rate of heat release by combustion is not necessarily in balance with the instantaneous heat requirement of the retort. This applies particularly to a single retort that is operated batch-wise: the process fluid is mainly released during a production phase, which is largely exothermic and which occurs at the second part of the retorting cycle, whereas a substantial amount of heat is required during the preceding heating phase, which is largely endothermic, especially at the beginning of the heating phase. Therefore, the technical feasibility of using the heating fluid as the only fuel for heating a batch retorting process is not immediately obvious, and actually is not technically feasible under many circumstances.

A first known approach to above problem of heating a retort at the required rate, is to use an additional fuel, such as fuel oil, coal or wood. Using an additional fuel requires that the additional fuel be acquired, e.g., through purchasing the additional fuel from a supplier, or through producing the additional fuel oneself. A disadvantage of using an additional fuel is that this eventually adds to the costs of processing the substance.

A second known approach to above problem is sometimes sought by operating a first retort and a second retort simultaneously. The second approach is implemented in the Twin Retort, described in: P. J. Reumerman and B. Frederiks, Charcoal Production with Reduced Emissions, 12th European Conference on Biomass for Energy, Industry and Climate Protection, Amsterdam, 2002. A similar solution is described in Dutch patent NL 1007299 (“Wood charcoal production process”).

This second approach is particularly suitable if the heating phase of a retorting cycle is endothermic and the production phase is exothermic. According to this approach, the first retort is then being operated in the exothermic phase, thereby providing the heating fluid that serves as a fuel for heating the second retort being operated in the endothermic phase. Upon completion of the endothermic phase of the second retort, the second retort enters the exothermic phase, thereby providing the heating fluid that serves as a fuel for heating the first retort that is entering its own endothermic phase when starting to process a next batch of the substance in the endothermic phase of the next production cycle. Under specific conditions, a continual process is conceivable that is self-sustained in energy.

In the second approach, a first condition, needed for maintaining a self-sustained continual production process, is that the heat of combustion of the total amount of the process fluid produced during a production cycle of one retort represents at least the amount of energy that is required by the entire endothermic phase of the other retort. However, if this condition is satisfied, it is not yet necessarily implied that the production system described here can be continual and self-sustained. Additional conditions for this second approach to be continual and self-sustained are the following.

A second condition is that, at any given moment, the instantaneous flow of sensible heat from the combustion of the heating fluid released from one retort should be larger than, or equal to, the instantaneously required heat flow of the other retort.

A third condition, following from the second additional condition, is that the duration of the endothermic phase should be shorter than, or equal to, the duration of the exothermic phase. If this were not so, the operation would run out of fuel at a critical part of the production cycle.

If these first, second and third conditions are not satisfied, continual operation requires the use of an additional fuel. The stability of an existing production system, designed according to this second approach, is highly susceptible to fluctuations in the quality of the raw substance to be processed. For example, the duration of the endothermic phase, the instantaneous quality of the heating fluid, and the instantaneous release rate of the heating fluid all depend on properties of the raw substance. Examples of such properties are the morphology (particle size distribution and shape) of the substance and moisture content of the substance. These properties may vary over time and per batch. Additional equipment may be needed to stabilize the production system according to this second approach. For example, in order to remove the moisture, a dryer may be employed prior to starting the processing of the substance in the retorts.

Moreover, this second approach suffers from operational vulnerabilities: preferably, the properties of the raw substance are controlled carefully and the phasing of retort operation is timed carefully.

The presence of above first, second and third conditions may give rise to several disadvantages. Additional fuel may be needed, or a loss of production capacity may occur if additional fuels are not used. Additional equipment may be needed for conditioning the raw substance to be processed. An existing production facility may become unsuitable for processing the raw substance, whose properties or quality deviate too much from the design specifications. And the production process is susceptible to operational fluctuations.

### SUMMARY OF THE INVENTION

In view of the above, the inventor proposes a third approach, in order to make a better use of the combustible process fluid that is released during the processing of the substance in the retort.

An embodiment of the invention relates to a processing system for processing a substance, e.g., decomposing the substance. The processing system is configured for processing the substance in subsequent batches. The substance releases a combustible process fluid during the processing. The processing system comprises a batch-wise operated retort, configured for processing the substance a single batch at a time. The processing system also comprises a combustor, connected to the retort for receiving at least a part of the combustible process fluid released by the substance in the retort, and operative to combust the received part of the combustible process fluid for generating heat. The processing system further comprises temporary heat storage for temporarily storing buffered heat, and a heat distribution system. The heat distribution system is coupled to the combustor, the temporary heat storage and to the retort and is configured to distribute the generated heat between the temporary heat storage and the retort, and to supply the buffered heat to the retort. The processing system further has a control system configured for controlling the heat distribution system for: supplying the generated heat to the retort under control of an instantaneous heat requirement of the processing of the substance in the retort; supplying at least part of the buffered heat to the retort under control of the instantaneous heat requirement; and increasing the buffered heat by storing in the temporary heat storage at least another part of the generated heat if the other part of the generated heat exceeds the instantaneous heat requirement.

The invention is based on the following insights. The rate, at which the combustible process fluid is being released by the substance, and also the instantaneous quality of the combustible process fluid, are a direct result of the processing rate and progress. Therefore, the instantaneous production of the combustible process fluid cannot be controlled independently of the heat requirement of the retorting process. In addition, the release of the combustible process fluid by the substance cannot be controlled directly (i.e., in real-time), but only with a substantially delayed response through controlling the heat flow to or from the retort. If the supply of heat to the retort is halted, the reaction of the raw substance and, therefore, the release of the process fluid, will continue for a while, due to the heat capacity of the retort and its contents. As mentioned above, the part of the process fluid that is used for being combusted in order to generate the heat is referred to as the “heating fluid”. Storing the heating fluid itself for future use is not without difficulties. Valves and conduits of an arrangement for storing the heating fluid may get clogged as a result of partial condensation of the heating fluid. The heating fluid can be combusted immediately upon release. The heat that is generated by combustion of the heating fluid can be of a high temperature. The heat itself can therefore be stored as sensible heat, available for use if and when needed, and available at a rate required through a suitable control mechanism.

In an approach according to the invention, the heat produced by combusting the heating fluid, e.g., a reaction vapor, is temporarily stored in temporary heat storage, and is made available for the transfer of heat to the retort when needed later on. Using an additional fuel for heating a retorting process can be avoided entirely, if at least one condition is fulfilled, namely if the heat of combustion of the total amount of process fluid, released by the substance being processed in the retort, equals at least the amount of energy required by the total of endothermic phases of the production cycle. If this condition is not satisfied, additional fuel is needed for heating. However, the amount of additional fuel required is reduced by making use of the approach in the invention.

An example of the processing in the embodiment of the invention includes decomposing of the substance by means of applying heat (pyrolysis). The substance is, e.g., wood or another organic biomass, that is to be processed for making e.g., charcoal and/or organic acids. Other examples of substances and of processing modes that can benefit from the invention are the following: pyrolysis of waste rubber tires for recovery of carbon, pyrolysis of waste that is contaminated with asbestos for deactivating toxicity, pyrolysis of residual plastics for recovery of monomers, recovery of shale oil from oil shale, etc.

For example, operating the processing system of this embodiment of the invention involves the following. It is first decided which part of the combustible process fluid, e.g., a reaction vapor, shall be made available as the heating fluid for the heat supply of a retorting process, and which part of the process fluid shall be used for other purposes, such as for the recovery of chemicals from the process fluid.

The heating fluid is combusted whenever it is being released (i.e., upon its becoming available to the combustor). To the extent needed by the processing of the substance in the retort, all, or part of, the heat resulting from combustion of the heating fluid is immediately provided to the retort process, and any surplus heat is stored in the temporary heat storage as sensible heat. Surplus heat is that portion of the heat, resulting from the combustion of the heating fluid, that exceeds the instantaneous heat requirement of the retort.

The temporary heat storage acts as a means to store thermal energy. The temporary heat storage is a thermal energy storage configured for temporarily storing heat in a repository that is, preferably, thermally insulated. The temperature level of the stored heat is selected such that relative to the retorting process the stored heat is available as sensible heat; that is, the temperature of the retorting process should be substantially lower than the temperature of the stored heat. In this manner, the stored heat is then available for later use. Several technologies are known to implement temporary thermal energy storage. The temporary thermal energy storage may be configured for so-called sensible heat storage (SHS), comprising a quantity of a material of a substantial heat capacity, or the temporary thermal heat storage may be configured for latent heat storage (LHS), comprising a quantity of a material of a substantial heat of fusion. For example, an SHS, as known in the art, comprises a mass of an inert material of a sufficiently large heat capacity. The mass of inert material is mounted inside a packed bed, through which a hot fluid, e.g., a flue gas, can be flown. Examples of such inert material are stone elements, refractory elements or metal elements. On the other hand, an LHS as known in the art, comprises a mass of an inert material of an elevated melting point and of a high heat of fusion. The mass of inert material is mounted inside a packed bed through which a hot fluid, e.g., a flue gas, can be flown. Suitable materials for LHS comprise, e.g., water, selected salts or metals. For example, the temporary thermal energy storage comprises aluminum that has a melting temperature of 660° C. If the combustor produces a combustion fluid of about 1000° C. as a result of combusting the heating fluid, the aluminum can be melted. Heat can be recovered through congealing of the aluminum for heating up the retort to about 560° C. Accordingly, the phase change that the aluminum or another material can undergo can be used for the temporary storage of heat.

In summary, heat can be added to the temporary heat storage by making a fluid (a gas or a liquid) of a temperature, higher than that of the temporary heat storage, flow through the temporary heat storage, and heat can be reclaimed from the temporary heat storage by making a fluid of a temperature, lower than that of the temporary heat storage, flow through the temporary heat storage. The temperature of the high-temperature fluid decreases as the high-temperature fluid is flowing through the temporary heat storage and transfers heat to the temporary heat storage, and the temperature of the low-temperature fluid increases as the low-temperature fluid is flowing through the temporary heat storage and receives heat from the temporary heat storage. The transfer of heat from the fluid to the retort and the transfer of heat from the temporary heat storage to the fluid may be implemented using any suitable technology based on any of, e.g., convection, conduction and radiation or a combination thereof. The fluid that is used to add heat to the temporary heat storage may, but need not, be chemically different from the fluid that is used to reclaim heat from the temporary heat storage.

During the adding of heat to the temporary heat storage and during the reclaiming of heat from the temporary heat storage, the amount of heat, stored in the temporary heat storage changes. A change of the amount of heat stored in the temporary heat storage is tangible as a change of the thermodynamic state of the temporary heat storage (e.g., the average temperature of the temporary heat storage in the case of an SHS, or the phase condition of the materials of the temporary heat storage in the case of an LHS).

To the extent needed by the retorting process, i.e., whenever there is not sufficient heat available from the immediate combustion of the instantaneously available heating fluid, heat is taken from the temporary heat storage by making a low-temperature fluid to flow through the temporary heat storage. The low-temperature fluid is heated and the thus heated fluid is transported to the retort. At the retort, the heated fluid is made to transfer its heat to the retort so that the total of heat supplied to the retort is in balance with the retort's need for heat. Many types of fluids are suitable for transferring heat from the temporary heat storage to the retort. Examples are air, thermal oil, flue gas from the combustion, and water vapor from drying the substance in the retort. The suitability of these examples of the fluid depends on, e.g., the temperatures that prevail in a specific retorting process, on the thermal properties of such fluids (such as thermal conductivity and thermal emissivity), on the implementation of the temporary heat storage, and also on the availability of such fluids for use during the retorting process.

Consider the fluid that is used for transfer of heat to the retort when the fluid has cooled down as a result of its having transferred heat to the retort. In an example embodiment, the cooled down fluid is made to flow through the temporary heat storage in order to be re-heated. If the fluid was used to reclaim heat from the temporary heat storage before transferring heat to the retort, the fluid can be made to (re-) circulate between the temporary heat storage and the retort for repeated use. Alternatively, or in addition, the fluid can be air, a flue gas resulting from the combustion of the heating fluid in the combustor, water vapor as a result of the drying of the substance in the retort, etc., without having the fluid circulating between the temporary heat storage and the retort.

The transfer of heat to or from the temporary heat storage, and the transfer of heat to the retort by means of a fluid can be realized in many ways. The person skilled in the art is able to select suitable fluids, and to design the proper methods and embodiments that enable effective heat transfer from a fluid to the retort, from the temporary heat storage to a fluid and from a fluid to the temporary heat storage. The fluid that is used to add heat to the temporary heat storage and the fluid that is used to reclaim heat from the temporary heat storage may, but need not, be chemically different fluids as will be illustrated later in this text by examples.

He may thereby refer to general handbooks, e.g. to ‘Perry's Chemical Engineers' Handbook’ or Backhurst, Harker, Richardson and Coulson, Chemical Engineering Volume 1: Fluid Flow, Heat Transfer and Mass Transfer', that provide to him all the relevant information.

In a further embodiment of the processing system in the invention, the control system comprises a sensor system for sensing a physical parameter, representative of the instantaneous heat requirement, and for supplying a sensor signal representative of the physical parameter. The control system comprises a controller. The controller is configured for receipt of the sensor signal, and for generating a control signal for control of the heat distribution system in dependence on the sensor signal received. Examples of the physical parameter are: a temperature measured at or in the retort; a concentration of oxygen of the combustion fluid; a concentration of carbon monoxide of the combustion fluid. Measurements of the oxygen concentration of the combustion fluid and/or of the carbon monoxide concentration of the combustion fluid are combined with the measurement of the flow of air supplied to the combustor that produces the combustion fluid. The measured oxygen concentration and/or the carbon monoxide concentration of the combustion fluid are/is representative of the efficiency of the combustion process in the combustor as well as of the progress of the processing of the substance in the retort. Measuring the oxygen concentration and/or the carbon monoxide concentration therefore enables to control the processing of the substance as well as to control the air supply to the combustor for control of the combustion of the heating fluid.

In this further embodiment the controller comprises, e.g., a signal processor. The signal processor receives one or more sensor signals from the sensor system. The signal processor generates one or more control signals for control of the heat distribution. For example, the heat distribution system comprises a pipeline system for the transport of heat by means of one or more fluids. The pipeline system comprises one or more valves and/or one or more pumps for control of the transport of the fluid and, therefore, of the heat. A specific one of the valves has an actuator for adjusting the specific valve in response to a specific control signal received from the controller. The pipeline system may comprise one or more pumps for moving the fluid, which is used for the heat transport, through the pipeline system. The controller may supply one or more further control signals for control of the one or more pumps in dependence on the sensor signals. The signal processor may be a dedicated piece of hardware, e.g., an electronic circuit wherein the processing is hard-wired, or a generic signal controller wherein the one or more sensor signals are processed under control of dedicated software, or a combination of dedicated hardware and generic hardware and dedicated software.

In another embodiment, the control system is configured for manual control of the heat distribution system. For example, the control system comprises a plurality of handles or levers or other types of controls for being manually operated by a human operator of the processing system. The manually operated controls are mechanically, hydraulically or electrically coupled to the valves and/or to the pumps in the pipeline system so as to convert a manual input from the human operator to the control system into an adjustment of the valves and/or of the pumps. The human operator operates the manual controls in dependence on his/her observations of the evolution of the processing (e.g., watching a thermometer coupled to the retort and/or in dependence on his/her experience).

In a further embodiment of the processing system of the invention, the combustor produces a combustion fluid as a result of combusting the received part of the process fluid for generating heat. The heat distribution system is configured for selectively transferring at least part of the generated heat to the temporary heat storage by means of channeling at least part of the combustion fluid from the combustor to the temporary heat storage; reclaiming at least part of the buffered heat by means of channeling a reclaiming fluid via the temporary heat storage; and heating the retort by means of channeling to the retort a conveying fluid that comprises at least one of: the reclaiming fluid and at least a part of the combustion fluid.

The expression “reclaiming fluid” is used in this text to refer to the specific fluid that is used to reclaim the buffered heat, or a part thereof, from the temporary heat storage. The reclaiming fluid comprises, e.g., air, taken from outside the processing system via a blower or a fan. Alternatively, the reclaiming fluid comprises at least part of a particular fluid that has been used to transfer heat to the retort. The expression “conveying fluid” is used in this text to refer to that particular fluid that is channeled to the retort for transferring at least part of the heat, carried by the particular fluid, to the retort. The conveying fluid comprises, e.g., at least part of the combustion fluid as supplied by the combustor and/or at least part of the reclaiming fluid exiting the temporary heat storage. Accordingly, the reclaiming fluid may comprise at least part of the conveying fluid after the conveying fluid has heated the retort and, as a consequence, has cooled down.

The expression “combustion fluid” as used in this text means to cover all fluids exiting the combustor. The combustion fluid may comprise not only reaction products as a result of the combusting of the portion of the process fluid that is used as the heating fluid, but also all other fluids that the combustor receives from the retort and that do not get chemically involved in the combustion, e.g., water vapor that has become available at a low temperature, e.g., when drying the substance.

In a further embodiment, the processing system comprises a batch-wise operated further retort, configured for processing a further substance a further single batch at a time. The processing of the further substance in the further retort releases a combustible further process fluid. The combustor is connected to the further retort for receiving at least a further part of the further process fluid released by the further substance in the further retort. The combustor is operative to combust the received further part of the further process fluid for generating further heat. The heat distribution system is coupled to the further retort. The heat distribution system is configured for distributing the generated heat and the generated further heat between the temporary heat storage, the retort and the further retort. The heat distribution system is also configured for distributing the buffered heat between the retort and the further retort. The control system is configured for controlling the heat distribution system for: supplying at least one of the generated heat and the generated further heat to the retort under control of the instantaneous heat requirement; supplying at least one of the generated heat and the generated further heat to the further retort under control of a further instantaneous heat requirement of the processing of the further substance in the further retort; supplying at least part of the buffered heat to the further retort under control of the further instantaneous heat requirement; and increasing the buffered heat by storing in the temporary heat storage at least a further part of the generated further heat if the further part exceeds at least one of the instantaneous heat requirement and the further instantaneous heat requirement.

A part of the further process fluid, released by the further substance in the further retort during the processing, can be used for generating further heat by combusting. The part of the further process fluid used for combusting, is referred to in this text as the “further heating fluid”. Using multiple retorts enables to use the heat, generated during an exothermic phase of the processing in one of the retorts, to drive the processing in another one of the retorts and/or to increase the amount of heat stored in the temporary heat storage. The expressions “substance” and “further substance” have been used here to cover the scenario wherein the substance and further substance are chemically and/or physically the same, and another scenario wherein the substance and further substance are chemically or physically different. The invention can be applied to both scenarios.

In a further embodiment, the control system comprises a sensor system for sensing a physical parameter, representative of an instantaneous heat requirement of the processing of the substance in the retort, and for sensing a further physical parameter, representative of a further instantaneous heat requirement of the processing of the further substance in the further retort. The sensor system is operative to supply a sensor signal representative of the physical parameter and a further sensor signal representative of the further physical parameter. The control system comprises a controller that is configured for receipt of the sensor signal and the further sensor signal, and for generating a control signal for control of the heat distribution system in dependence on the sensor signal received and the further sensor signal received.

Examples of the further physical parameter are: a temperature measured at or in the further retort have been given above.

In this further embodiment, the heat distribution system is configured for distributing the heat, generated by combustion of the heating fluid, and the further heat, generated by combustion of the further heating fluid, between the temporary heat storage, the retort and the further retort, and for distributing the stored heat of the temporary heat storage between the retort and the further retort. The heat distribution system is controlled by the control system in response to receiving one or more sensor signals representative of the physical parameter and the further physical parameter.

In a further embodiment, the processing system is configured for the processing of the substance in the retort in one of: an endothermic phase and an exothermic phase when the processing of the further substance in the further retort is in the other one of the endothermic phase and the exothermic phase.

The substance and/or the further substance may comprise a biomass and the processing comprises at least one of: making of charcoal by the processing of the biomass; making of a liquid distillation product by the processing of the biomass; and making of a gaseous distillation product by the processing of the biomass.

The invention also relates to a method of processing a substance in subsequent batches. The substance releases a combustible process fluid during the processing. The method comprises: using a batch-wise operated retort, configured for processing the substance a single batch at a time; receiving at least part of the combustible process fluid released by the substance in the retort; combusting the received part of the process fluid in a combustor for generating heat; using temporary heat storage for storing buffered heat; and controlling the processing. The controlling comprises: determining an instantaneous heat requirement of the processing of the substance in the retort: supplying at least part of the generated heat to the retort under control of the instantaneous heat requirement; supplying at least part of the buffered heat to the retort under control of the instantaneous heat requirement; and increasing the buffered heat by storing in the temporary heat storage at least another part of the generated heat if the other part of the generated heat exceeds the instantaneous heat requirement.

In an embodiment of the method, the determining of the instantaneous heat requirement comprises sensing a physical parameter, representative of the instantaneous heat requirement. The supplying of the at least part of the generated heat, the supplying of the at least part of the buffered heat, and the increasing of the buffered heat are controlled in dependence on the sensing.

In a further embodiment of the method, the combusting produces a combustion fluid as a result of combusting the received part of the process fluid. The controlling comprises: selectively transferring at least part of the generated heat to the temporary heat storage by means of channeling at least part of the combustion fluid from the combustor to the temporary heat storage; selectively reclaiming at least part of the buffered heat by means of channeling a reclaiming fluid via the temporary heat storage; and selectively heating the retort by means of channeling to the retort a conveying fluid that comprises at least one of: the reclaiming fluid and at least a part of the combustion fluid.

In a further embodiment of the method, the reclaiming fluid comprises at least part of the conveying fluid after the conveying fluid has heated the retort.

In a further embodiment of the method, the method comprises using a batch-wise operated further retort, configured for processing a further substance a further single batch at a time. The processing of the further substance in the further retort releases a combustible further process fluid. The method comprises receiving at least a further part of the further process fluid released by the further substance in the retort; and combusting the received further part of the further process fluid for generating further heat. The method also comprises: distributing the generated heat and the generated further heat between the temporary heat storage, the retort and the further retort, and distributing the buffered heat between the retort and the further retort; determining a further instantaneous heat requirement of the processing of the further substance in the further retort; and controlling the distributing. The distributing is controlled for: supplying at least one of the generated heat and the generated further heat to the retort under control of the instantaneous heat requirement; supplying at least one of the generated heat and the generated further heat to the further retort under control of the further instantaneous heat requirement; supplying at least part of the buffered heat to the further retort under control of the further instantaneous heat requirement; and increasing the buffered heat by storing in the temporary heat storage at least a further part of the generated further heat if the further part exceeds at least one of the instantaneous heat requirement and the further instantaneous heat requirement.

In a further embodiment, the controlling comprises sensing a physical parameter, representative of the instantaneous heat requirement of the processing of the substance in the retort, and sensing a further physical parameter, representative of the further instantaneous heat requirement. The supplying of at least one of the generated heat and the generated further heat to the retort, the supplying of at least one of the generated heat and the generated further heat to the further retort, the supplying of at least part of the buffered heat to the further retort, and the increasing of the buffered heat by storing in the temporary heat storage at least a further part of the generated further heat are controlled in dependence on the sensing.

In a further embodiment, the controlling is configured for the processing of the substance in the retort in one of: an endothermic phase and an exothermic phase when the processing of the further substance in the further retort is in the other one of the endothermic phase and the exothermic phase.

In a further embodiment, the substance and/or the further substance comprise/comprises a biomass and the processing comprises at least one of: making of charcoal by the processing of the biomass; making of a liquid distillation product by the processing of the biomass; and making of a gaseous distillation product by the processing of the biomass.

For completeness, reference is made to GB patent 439,824. The text and drawings of GB 439,824 disclose a system for a low-temperature carbonization process of briquettes. The known system comprises reactor, which is referred to as “a retort” in the text of GB patent 439,824. The known system is configured for a continuous carbonization process. The briquettes gravitate down the reactor. The known system uses a pair of thermal regenerators for storing heat. The thermal regenerators are used alternately for heating a gas that flows through the reactor. The heated gas continuously provides all the heat required by the continuous carbonization process. The heated gas flows through the reactor to heat-up the briquettes, after which the gas is guided back to the thermal regenerator to be heated and reused as gas to heat the briquettes. This continuous process requires that the two thermal regenerators be used alternately, because the time interval during which one of the regenerators is used to store energy, it is not available for transferring heat to the gas. During this time interval the gas is heated by the other one of the regenerators.

Note that the term “retort”, as used in the description of the current invention, refers to a device that is not configured for a flow-through operation, in contrast to the reactor described in the text of GB patent 439,824. In the flow-through operation a gas is flown through the reactor in order to transfer heat from the gas directly to the substance contained within the reactor.

The system of GB patent 439,824 is designed for continuous operation, and not for a batch-wise operation, in contrast with the processing system in the invention. As a consequence, the issue is not addressed of temporary heat storage for heating the reactor in an endothermic phase of the processing and for accumulating heat during an exothermic phase of the processing. Furthermore, the system of GB patent 439,824 needs at least two heat regenerators, whereas for the system of the invention a single temporary heat storage suffices. Another difference between the invention and the known system of GB patent 439,824 is that the known system is configured for storing all heat, generated by combusting any processing fluid, whereas the processing system of the invention only stores the surplus heat. Still another difference relates to the following. In the invention, the capacity of the temporary heat storage depends on the differential of the total process heat requirement and the total amount of heat that can be provided (in view of the instantaneous availability) directly from the combustor to the retort. On the other hand, GB patent 439,824 does not address the issue of the capacity of the set of thermal regenerators and solely depends upon the acceptable service period of a single one of the thermal regenerators. Yet another difference is the following. In GB 439,824, the sole functionality of the thermal regenerators is that of a gas-to-gas heat exchanger so as to arrange a physical separation between the recirculating inert gas and the hot gaseous combustion products. In the invention, on the other hand, the separation is entirely provided by the wall of the retort, whereas the functionality of the temporary heat storage is to neutralize the discrepancy between the release rate of the heating fluid and the heat requirement of the retort, by means of alternately storing and providing heat. Furthermore, in the invention, the primary source of heat sustaining the retorting process is the heat of combustion of the heating fluid, taken directly from the combustor. The temporary heat storage merely provides a supplement of heat up to the level required by the retorting process. Thus, in the invention, only part of the process heat required by the retorting process is provided from the temporary heat storage. Also, in the invention, gas flows to and from the temporary heat storage are controlled in view of the endothermic or exothermic character of the retort's processing phase. In contrast, the known system of GB patent 439,824 controls the gas flows in dependence on the thermal state of the thermal regenerator, which is full of heat or which is empty.

For completeness, further reference is made to JP patent application publication 2003/138270 A. JP patent application publication 2003/138270 A discloses a carbonization apparatus with a carbonization furnace (10) and a heat storage. The heat storage serves to store heat at one moment, and to make the stored heat available at another moment to a fuel gas so as to raise the temperature of the fuel gas up to a level such that the fuel gas can ignite and burn properly. The functionality of the heat storage in JP patent application publication 2003/138270 A is to create the conditions suitable for a combustion reaction. A properly executed combustion reaction of the fuel gas is needed to minimize polluting gaseous emissions. The heat storage in JP patent application publication 2003/138270 A is dimensioned and configured for that particular duty. In contrast, the temporary heat storage of the current invention serves to provide process heat to the substance in the retort (rather than creating combustion conditions for a fuel gas as in JP patent application publication 2003/138270 A), and is dimensioned for that purpose. Since the temporary heat storage of the current invention is equipped with a control system for the purpose of providing process heat, the temporary heat storage is substantially different from the heat storage in the system of JP patent application publication 2003/138270 A. Further, the process description in JP patent application publication 2003/138270 A shows that the fuel gas, for which combustion conditions need to be upgraded, is diluted with combustion products. This is the result of a direct contact between the combusted gas and the material that is subjected to the carbonization process. The carbonization furnace, described in JP patent application publication 2003/138270 A, is therefore not a retort, as specified in the current invention. The carbonization furnace of JP patent application publication 2003/138270 A is referred to as being a “rotary furnace”. A rotary furnace is well known in the art as an example of an apparatus designed for a continuous process. Such an apparatus designed for a continuous process differs essentially from the batch-wise operated retort used in the current invention.

Yet a further reference is made to German published patent application DE 102005001569 A1. German published patent application DE 102005001569 A1 discloses a heat exchanger (“Warmetauscher”) that is operative to pre-heat the air supplied to a burner (“Brenner”) and the air supplied to a heating chamber (“Heizraum”). The heat of the exhaust gases (“Abgase”), while on their way out of the system, is used in the heat exchanger to pre-heat the air used for combustion.

The system of German published patent application DE 102005001569 A1 does not make use of temporary heat storage, but rather of a heat exchanger. The expression “temporary heat storage” and “heat exchanger” refer to concepts that are functionally different, and are therefore contrived differently from different technical parts. Temporary heat storage is configured for accumulating instantaneously available heat for release at a later moment. To this end, the temporary heat storage comprises a heat storage medium. Temporary heat storage is essentially characterized by a phased operation (stationary operation is physically impossible), manifest from a change of a physical parameter of the matter of which the temporary heat storage is made. Such parameter may comprise a temperature or a changeable aggregation state (gas to liquid and vice versa, or liquid to solid and vice versa). A heat exchanger, on the other hand, is configured for transferring heat from one entity to another entity. A heat exchanger can be operated in a stationary manner (whereby device parameters are not subject to change but rather stay constant over time). In operational use, the temporary heat storage necessarily cooperates with at least one heat exchanger so as to enable the transfer of heat into or from the heat storage medium of the temporary heat storage. In the system of German published patent application DE 102005001569 A1 there is no storage of heat, but merely a continuous process of heat transfer. A further reference is made to US patent application publication 2006/0163053 A1, which discloses a batch pyrolysis system, claiming certain process optimizations. US patent application publication 2006/0163053 A1 does not disclose the use of temporary heat storage, but rather of a heat exchanger. Both German published patent application DE 102005001569 A1 and US patent application publication 2006/0163053 A1 are unambiguous in the meaning of the expression “heat exchanger” and in the role of the heat exchanger in their respective systems as disclosed.

### BRIEF DESCRIPTION OF THE DRAWING

The invention is explained in further detail, by way of example and with reference to the accompanying drawing, wherein:

FIG. 1 is a block diagram of a first embodiment of a processing system in the invention;

FIG. 2 is a block diagram of a second embodiment of a processing system in the invention;

FIG. 3 is a diagram for explaining the expressions “endothermic and exothermic” as used in describing the invention;

FIG. 4 is a flow diagram of a method in the invention;

FIG. 5 is a block diagram of a third embodiment of a processing system in the invention; and

FIG. 6 is a block diagram of a fourth embodiment of a processing system in the invention.

Throughout the Figures, similar or corresponding features are indicated by same reference numerals.

### LEGEND

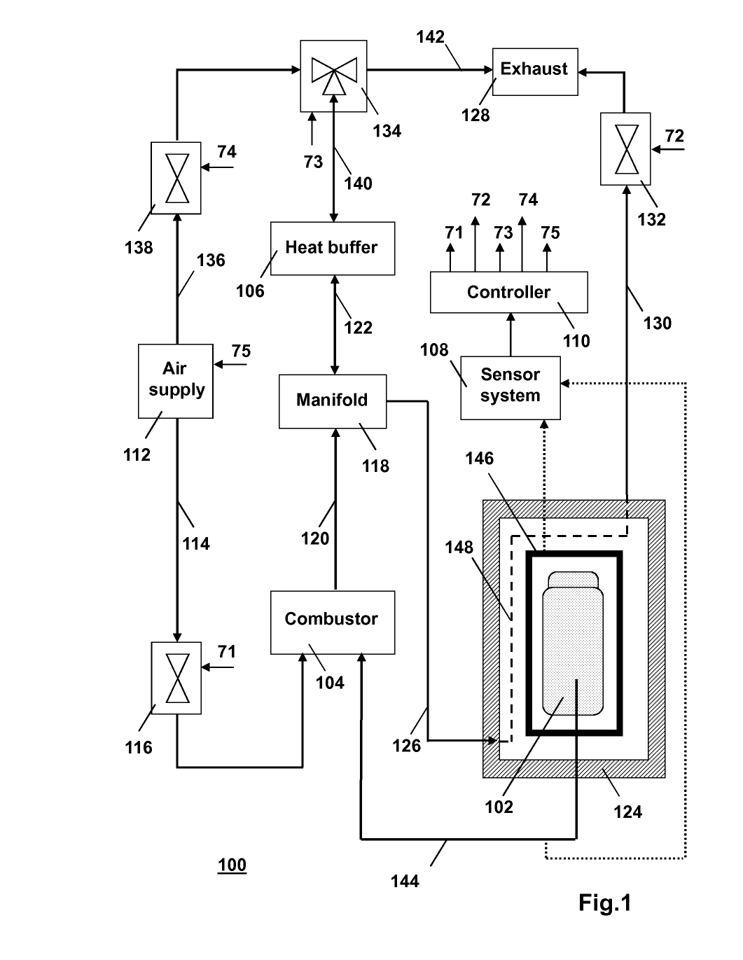

Below is a list of reference numerals that are being used throughout the block diagrams of FIGS. 1, 2, 5 and 6.
71: first control signal for control of first valve
72: second control signal for control of second valve
73: third control signal for control of third valve
74: fourth control signal for control of fourth valve
75: fifth control signal for control of air supply
76: sixth control signal for control of fifth valve
81: seventh control signal for control of fluid circulation pump 502
100: first embodiment
102: retort
104: combustor
106: heat buffer
108: sensor system
110: controller
112: air supply
114: first pipe interconnecting air supply 112 and combustor 104
116: first valve in first pipe 114
118: manifold
120: second pipe interconnecting combustor 104 and manifold 118
122: third pipe interconnecting manifold 118 and heat buffer 106
124: container
126: fourth pipe interconnecting manifold 118 and container 124
128: exhaust
130: fifth pipe interconnecting container 124 and exhaust 128
132: second valve in fifth pipe 130
134: third valve (three-way valve)
136: sixth pipe interconnecting air supply 112 and third valve 134
138: fourth valve in sixth pipe 136
140: seventh pipe interconnecting third valve 134 and heat buffer 106
142: eighth pipe interconnecting third valve 134 and exhaust 128
144: ninth pipe interconnecting retort 102 and combustor 104
146: wall in container 124
148: passageway through container 124
200: second embodiment
202: further retort
204: further container
206: further wall in further container 204
208: tenth pipe interconnecting further retort 202 and combustor 104
210: eleventh pipe
212: fifth valve in eleventh pipe 210
214: twelfth pipe interconnecting manifold 118 and the further container 204
216 passageway through further retort 202
500: third embodiment
502: fluid circulation pump
504: thirteenth pipe between fluid circulation pump 502 and third valve 134
506: fourteenth pipe between fluid circulation pump 502 and second valve 132
600: fourth embodiment

### DETAILED EMBODIMENTS

The invention relates to processing a batch of a substance, e.g., a biomass, in a batch-wise operated retort under the application of heat. The substance releases a combustible process fluid during the processing. The process fluid is combusted for generating heat. The heat is supplied to the retort and/or stored in temporary heat storage in dependence on the progress of the processing.

FIG. 1 is a diagram of a first embodiment 100 of a processing system for processing a substance according to the invention. The processing system is configured for processing the substance in subsequent batches. The substance releases a combustible process fluid during the processing. The first embodiment 100 comprises a batch-wise operated retort 102 that is covered with a gas-tight lid during operational use. The retort 102 processes the substance a single batch at a time. The first embodiment further comprises a combustor 104, temporary heat storage 106, a sensor system 108 and a control system with a controller 110. The temporary heat storage 106 will be referred to herein below as “heat buffer 106”.

The retort 102, the combustor 104 and the heat buffer 106 are connected in a heat distribution system configured for distributing heat between the retort 102, the combustor 104 and the heat buffer 106 in operational use of the first embodiment 100, as will be described below.

The first embodiment 100 comprises a pipeline system. The pipeline system has: an air supply 112; a first pipe 114 connecting the air supply 112 to the combustor 104; a first valve 116 in the first pipe 114; a manifold 118; a second pipe 120 connecting the manifold 118 to the combustor 104; a third pipe 122 connecting the manifold 118 to the heat buffer 106; a container 124 of a heat insulating material for containing the retort 102; a fourth pipe 126 connecting the manifold 118 to the container 124; an exhaust 128; a fifth pipe 130 connecting the container 124 to the exhaust 128; a second valve 132 in the fifth pipe 130; a third valve 134 that is a three-way valve; a sixth pipe 136 connecting the air supply 112 to the third valve 134; a fourth valve 138 in the sixth pipe 136; a seventh pipe 140 connecting the third valve 134 to the heat buffer 106; and an eighth pipe 142 connecting the third valve 134 to the exhaust 128.

For completeness, it is remarked here that the term “pipe” is used herein by way of example to refer to means for channeling a fluid from one space to another space. Instead of a pipe, one could use, e.g., a duct, a tube or ports to establish a connection between two spaces to guide a fluid from one of the spaces to the other one of the spaces.

For completeness it is remarked here that the expression “three-way valve” may refer to a so-called three-port valve or to a configuration of two two-port valves that has similar functionality. A three-way valve has three ports. A typical three-way valve selectively guides a flow, coming in at one port, to one of the two other ports. A pair of two-port valves can be configured to function as a three-way valve. The configuration is then such that a respective one of the pair of two-port valves has its respective input port connected to a respective end of a branching fork in a single pipe. Their output ports are connected to different pipes.

The combustor 104 is, e.g., a furnace, and is connected via a ninth pipe 144 to the container 124, containing the retort 102, for receiving at least a part of the combustible process fluid released by the substance when being processed in the retort 102. The combustor 104 combusts the received part of the combustible process fluid for generating heat. The heat buffer 106 is configured for storing heat and releasing the stored heat. Examples of implementations of the heat buffer 106 have been mentioned above.

The sensor system 108 comprises, for example, a first temperature sensor (not shown) for sensing the temperature at a location on a wall 146 that is positioned in the container 124 and adjacent to the retort 102, or the temperature at a location on the wall 146 or on an outer surface of the retort 102 itself, and/or a second temperature sensor (not shown) for sensing the temperature of the process fluid at a location of the ninth pipe 144 close to the retort 102. The first temperature sensor comprises, e.g., a pyrometer. A pyrometer is a contactless measuring device that senses a temperature of an object's surface via the thermal radiation emitted by the object's surface. The second temperature sensor comprises, e.g., a thermocouple. A thermocouple comprises a junction of two different metals that generates a temperature-dependent voltage.

As yet another example, the sensor system 108 comprises a sensor (not shown) for sensing a concentration of oxygen of the combustion fluid, and/or a sensor (not shown) for sensing a concentration of carbon monoxide of the combustion fluid. The measured oxygen concentration and/or the carbon monoxide concentration of the combustion fluid, in combination with the measured flow of the combustion air, are/is representative of the efficiency of the combustion process in the combustor 104 as well as of the progress of the processing of the substance in the retort 102. Measuring the oxygen concentration and/or the carbon monoxide concentration therefore enables to control the processing of the substance as well as to control the air supply to the combustor 104, e.g., via the first valve 116, for control of the combustion of the heating fluid.

The controller 110 is connected to the sensor system 108. The controller 110 of the control system in the first embodiment 100 determines the heat supply to the heat buffer 106 and to the retort 102 under control of the one or more sensor signals received from the sensor system 108. For example, the temperature is measured at the retort 102. If the temperature is too low for the intended processing of the substance, the heat distribution system is controlled so as to generate a heat flow to the retort 102. The controller 110 may then control the heat flow in dependence on the rate of change of the temperature as measured via the sensor system 108.

The controller 110 controls the first valve 116 via a first control signal 71. The controller 110 controls the second valve via a second control signal 72. The controller 110 controls the third valve 134 via a third control signal 73. The controller 110 controls the fourth valve 138 via a fourth control signal 74.

The air supply 112 comprises, e.g., a fan with an air intake for receiving ambient air, or a pump, or a source of pressurized air, etc. The air supply 112 is operative to force the air into the first pipe 114 and into sixth pipe 136, depending on the states of the first valve 116 and the fourth valve 138. Optionally, the controller 110 controls the air supply 112 via a fifth control signal 75.

The manifold 118 comprises an arrangement of pipes for distributing the flow of a fluid through the heat distributing system under control of the first valve 116, the second valve 132, the third valve 134 and the fourth valve 138, as will be explained below. The sensor system 108 senses a physical parameter that is indicative of an instantaneous heat requirement for the processing of the substance in the retort 102 and generates one or more sensor signals representative of the instantaneous heat requirement.

In an example illustrated by the first embodiment 100, the combustible process fluid is burnt with oxygen within the combustor 104. The oxygen for the combustion is provided by the air that is supplied to the combustor 104 by the air supply 112 via the first pipe 114 and under control of the first valve 116. The combustion of the combustible process fluid in the combustor 104 produces a combustion fluid, e.g., a flue gas, that is supplied to the manifold 118 via the second pipe 120. The combustion fluid has an elevated temperature. The heat content of the combustion fluid is now used to provide energy for the batch-wise processing of the substance in the retort 102. This is explained as follows.

Assume that operation of the embodiment 100 is to be started up. In an example scenario, first the heat buffer 106 is heated up using, e.g., an additional fuel or an external heat source (not shown), e.g., solar energy. When the heat buffer 106 has reached a suitably high temperature, the retort 102 that contains a first batch of the substance to be processed, is mounted within the container 124.

In a first step, after the retort 102 has been mounted in the container 124, the second valve 132 and the fourth valve 138 are opened, and the third valve 134 is switched so as to provide a passageway from the sixth pipe 136 to the seventh pipe 140. Then, the air supply 112 creates a flow of cold air to the heat buffer 106 via the sixth pipe 136 and the seventh pipe 140. The cold air passes through the heat buffer 106. Heat is transferred from the heat buffer 106 to the cold air, and the cold air heats up. Hot air exits the heat buffer 106 and is supplied to the container 124 via the third pipe 122, the manifold 118, and the fourth pipe 126. During the passage of the hot air through the container 124, the hot air transfers heat to the wall 146 and cools down. The wall 146 transfers the heat to the retort 102, e.g., through radiation. The fifth pipe 130 guides the cooled-down air from the container 124 to the exhaust 128. For completeness it is remarked here that the transfer of heat from the hot air to the retort 102 may use a variety of mechanisms such as radiation (as via the wall 146), or convection or conduction, or any suitable combination thereof, and does not necessarily use a wall such as the wall 146. The wall 146 is mentioned here by way of example.

When the wall 146 is transferring its heat to the retort 102, the processing of the substance in the retort 102 begins. As time passes, the temperature of the retort 102 and the contained substance increases. The substance in the retort 102 then begins to release a process fluid, and the release rate increases as the temperature of the retort 102 increases. The release rate of the process fluid increases, as well as the combustibility of the process fluid. For example, consider the procedure wherein the substance comprises wood and the processing of the substance comprises the decomposing of the wood into charcoal. In this scenario, the process fluid may contain much steam and less methane at an early stage of the decomposing, whereas the process fluid may contain much methane and no steam at a later stage. Steam is incombustible, and methane is combustible.

As from the moment that the process fluid has become ignitable, all or part of the process fluid, released at the retort 102, is burnt in the combustor 104. The burning of the process fluid generates a hot combustion fluid, e.g., a flue gas. The hot combustion fluid is led via the second pipe 120 to the manifold 118. The hot combustion fluid mixes with the hot air at the manifold 118. The hot mixture of the hot combustion fluid and the hot air flows through the fourth pipe 126 to the container 124. During the passage of the hot mixture through the container 124, the hot mixture transfers heat to the wall 146 and cools down. The wall 146 transfers the heat to the retort 102, e.g., through radiation. The fifth pipe 130 guides the cooled-down mixture from the container 124 to the exhaust 128. For completeness it is remarked here that the transfer of heat from the mixture to the retort 102 may use a variety of mechanisms such as radiation, convection or conduction, or any suitable combination thereof, with or without intervention of a wall such as the wall 146.

The heat of the combustion of the process fluid contributes to the heat required by the processing of the substance in the retort 102. Accordingly, in a second step, the flow of hot air from the heat buffer 106 to the manifold 118 is reduced to a lower rate under control of the fourth valve 138. Over time, the release rate and the combustibility of the process fluid increase. However, the instantaneous heat requirement of the processing is still larger than the instantaneous heat provided by the combustion of the process fluid. Therefore, the processing is still in an endothermic phase.

Assume now that the moment has arrived, at which the rate and quality of the process fluid from the retort 102 are such that the processing of the substance in the retort 102 can be driven by the heat extracted from the combustion fluid alone. That is, the amount of heat immediately available from combusting the process fluid exceeds the amount of heat instantaneously required by the processing of the substance in the retort 102. This is the start of an exothermic phase. Then, in a third step, the third valve 134 and, optionally, the fourth valve 138 are controlled so as halt the flow of cold air to the heat buffer 106. As the combustion fluid flowing in the second pipe 120 carries more heat per unit of time than is required by the retort 102 for processing the substance, part of the combustion fluid is channeled to the heat buffer 106 for buffering the surplus heat. This is achieved in a fourth step by controlling the second valve 132 and the third valve 134. The third valve 134 is controlled so as to open up a passageway from the heat buffer 106 to the exhaust 128 via the seventh pipe 140 and the eighth pipe 142, and so as to firmly close the passageway for air from the sixth pipe 136 to the seventh pipe 140. The second valve 132 is controlled so as to create a back-pressure at the manifold 118 that forces the combustion fluid to flow to the container 124 via the fourth pipe 126 as well as to the heat buffer 106 via the third pipe 122. The part of the combustion fluid passing through the heat buffer 106 transfers heat to the heat buffer 106 and cools down. The seventh pipe 140 and the third valve 134 guide the cooled-down combustion fluid to the exhaust 128.

When the processing of the substance then continues, a moment will be reached at which the release of the process fluid has slowed down to such a low rate, that the processing of the first batch of the substance in the retort 102 is considered completed. The retort 102 is then dismounted and the processed substance is discharged from the retort 102. The controller 110 may temporarily turn off the air supply 112 via the fifth control signal 75, while the retort 102 is being removed from the container 124, emptied, filled with a next batch of the substance and replaced within the container 124.

The processing of each next batch in the retort 102 is a repetition of above scenario explained with reference to the first step, the second step, the third step and the fourth step.

For clarity: the control system in the embodiment 100 comprises the controller 110, the first valve 116, the second valve 132, the third valve 134, the fourth valve 138 and, optionally, the air supply 112. The second valve 132 has been described as being positioned in the fifth pipe 130, connecting the container 124 to the exhaust 128. The second valve 132 could, as an alternative, be located in the fourth pipe 126 that connects the manifold 118 to the container 124. However, a drawback of positioning the second valve 126 upstream of the container 124 is that the second valve 132 has to be configured for withstanding the relatively high temperatures of the hot air from the heat buffer 106 or of the hot combustion fluid from the combustor 104. If the second valve 132 is located downstream of the container 124, the temperature of the air and of the combustion fluid has dropped significantly, owing to the heat transfer to the retort 102 during its passage through the container 124.

Using the container 124 enables to quickly replace the retort 102, upon completion of the processing of the substance in the retort 102, with another retort (not shown) that has been prepared for subjecting a next batch of the substance to the processing. The container 124 further serves to absorb and retain the heat received from the hot air, or from the mixture of the hot air and the hot combustion fluid, and can be designed to have the proper heat capacity and proper thermodynamic characteristics to efficiently transfer the heat thus received to the retort 102. The container 124 may comprise, for example, a brick enclosure for accommodating the retort 102. The brick enclosure has one or more channels for guiding the hot air, the mixture of the hot air and the hot combustion fluid, or the combustion fluid, that enters the container 124 via the fourth pipe 126, toward the exit of the container 124 connected to the fifth pipe 130. On its way through the container 124, the hot air, the mixture of the hot air and the hot combustion fluid, or the combustion fluid transfers it heat to the retort 102. In the example shown in FIG. 1, dashed lines 148 schematically indicate the passageway of the hot air, of the hot mixture or of the hot combustion fluid, from the exit of the fourth pipe 124 via the container 124 to the entrance of the fifth pipe 130. The actual implementation of the passageway 148 through the container 124 is a design choice and may depend on, e.g., the desired efficiency of the heat transfer from the hot air, from the mixture or from the combustion fluid to the retort 102.

In the first embodiment 100 described above, it is assumed that the control system includes the controller 110, e.g., a signal processor, and the sensor system 108. The signal processor receives the one or more sensor signals from the sensor system 108 for generating the first control signal 71 for control of the first valve 116, the second control signal 72 for control of the second valve 132, the third control signal 73 for control of the third valve 134, the fourth control signal 74 for control of the fourth valve 138 and, optionally, the fifth control signal 75 for control of the air supply 112. The signal processor may be a dedicated piece of hardware, e.g., an electronic circuit wherein the processing is hard-wired, or a generic signal controller wherein the one or more sensor signals are processed under control of dedicated software, or a combination of dedicated hardware and generic hardware and dedicated software. In an alternative embodiment (not shown), both the sensor system 108 and the controller 110 are absent. Instead, the control system comprises a plurality of handles or levers or other types of controls (not shown) for being manually operated by a human operator. Each respective one of the controls is configured to manually control a respective one of the first valve 116, the second valve 132, the third valve 134, the fourth valve 138 and, optionally, the air supply 112. The handles or levers enable the operator to manually adjust the first valve 116, the second valve 132, the third valve 134, the fourth valve 138 and, optionally, the air supply 112, in dependence on his/her observations of the evolution of the process (e.g., watching a thermometer coupled to the retort 102 and/or in dependence on his/her visual observations of the combustion process and experience).

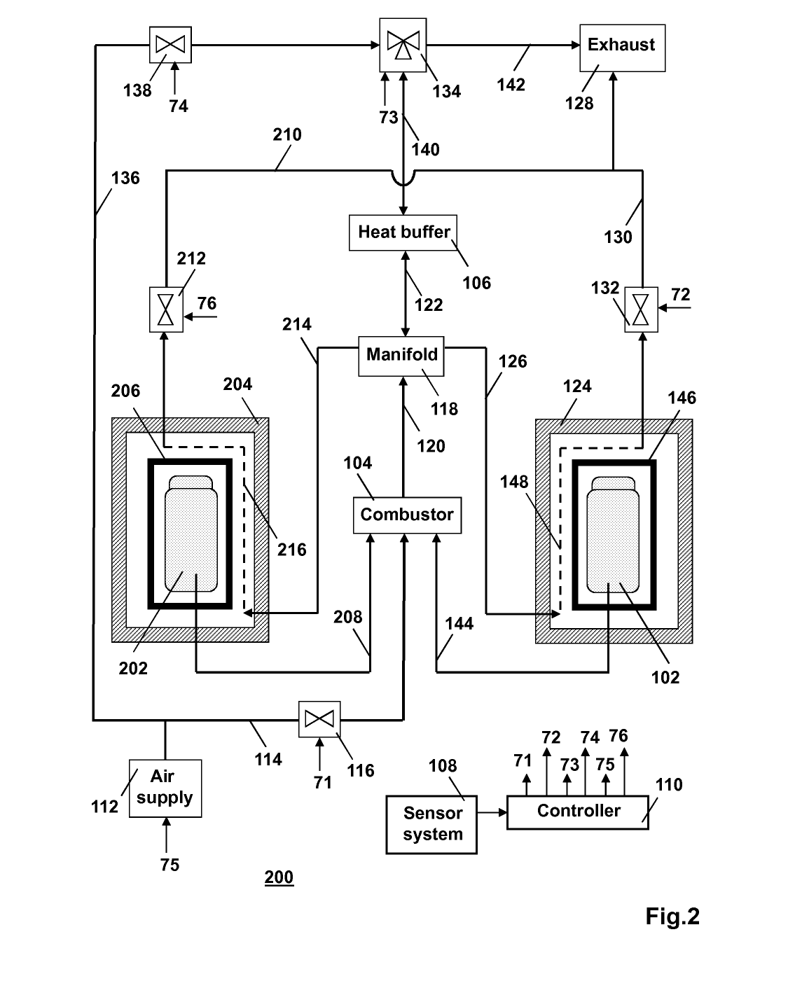

FIG. 2 is a diagram of a second embodiment 200 of a processing system for processing a substance according to the invention. The second embodiment 200 includes the first embodiment 100 discussed above with reference to FIG. 1. The second embodiment 200 has, in addition, a further retort 202 that, in operational use of the further retort 202, is placed in a further container 204. Both the retort 102 and the further retort 202 contain amounts of the substance to be processed. The further container 204 accommodates a further wall 206. The further container 204 is connected to the combustor 104 via a tenth pipe 208. The further container 202 is connected to the exhaust 128 via an eleventh pipe 210 accommodating a fifth valve 212. The further container 202 is also connected to the manifold 118 via a twelfth pipe 214. The passageway inside the further container 204 for the hot air, for the hot combustion fluid or for the mixture of hot air and hot combustion fluid from the twelfth pipe 214 to the eleventh pipe 210, is schematically indicated with dashed lines 216.

In the second embodiment 200, the sensor system 108 senses a physical parameter that is indicative of an instantaneous heat requirement for the processing of the substance in the retort 102, examples of which have been discussed above with reference to the first embodiment 100. The sensor system 108 also senses a further physical parameter that is indicative of an instantaneous heat requirement for the processing of the substance in the further retort 202 using, for example, one or more additional sensors of a similar type as discussed with reference to the first embodiment 100. In order to not obscure the drawing, the connections between the sensor system 108 and the retort 102, and the connections between the sensor system 108 and the further retort 202, are not explicitly shown in FIG. 2.

The controller 110 is connected to the sensor system 108, and receives one or more sensor signals that are indicative of the instantaneous heat requirement for the processing of the substance in the retort 102, as well as one or more further sensor signals that are indicative of the instantaneous heat requirement for the processing of the substance in the retort 202. The controller 110 of the control system in the second embodiment 200 determines the distribution of the available heat between the heat buffer 106, the retort 102 and to the further retort 202 under control of the one or more sensor signals and the one or more further sensor signals. The controller 110 controls the first valve 116 via the first control signal 71, the second valve 132 via the second control signal 72, the third valve 134 via the third control signal 73, the fourth valve 138 via the fourth control signal 74, the fifth valve 212 via the sixth control signal 76 and, optionally, the air supply 112 via the fifth control signal 75.

The ninth pipe 144 collects the process fluid from the retort 102 and transports the collected process fluid to the combustor 104. The tenth pipe 208 collects the further process fluid from the further retort 202 and transports the collected further process fluid to the combustor 104. At the combustor 104, the process fluid and the further process fluid are combusted with air from the air supply 112 via the first valve 116. The second pipe 120 removes the hot combustion fluid from the combustor 104 and guides the hot combustion fluid to the manifold 118.

The manifold 118 guides the hot combustion fluid to various components of the second embodiment 200 in dependence on the selected operational mode of the heat buffer 106. The operational mode of the heat buffer 106 is selected through control of the third valve 134, the fourth valve 138, the fifth valve 212 and, optionally, the air supply 112. The operational mode of the heat buffer 106 as temporary heat storage is selected by controlling the third valve 134 (the three-way valve) so as to block the passageway for the air from the air supply 112, and to open the passageway from the heat buffer 106 to the exhaust 128. The hot combustion fluid is enabled to flow from the combustor 104 through the heat buffer 106 to the exhaust 128. The rate of storing the heat in the heat buffer 106 depends on, among others, the flow rate of the hot combustion gas. The flow rate of the combustion fluid is regulated by the pressure drop across the relevant one of the second valve 132 and the fifth valve 212. The operational mode of the heat buffer 106 as a provider of process heat is selected by setting the third valve 134 so as to connect the air supply 112 to the heat buffer 106 and to block the passageway from the sixth pipe 136 to the eighth pipe 142. Again, the rate of the heat supply from the heat buffer 106 depends on the pressure drop across the relevant ones of the second valve 132 and the fifth valve 212.

The retort 102 and the further retort 202 may be operated in counter-phase. That is, the second embodiment is controlled so that, when the processing of the substance in the retort 102 is in an exothermic phase, the processing of the substance in the further retort 202 is in an endothermic phase and vice versa. Alternatively, the retort 102 and the further retort 202 may be operated independently of each other.

For each individual one of the retort 102 and the further retort 202, respective endothermic phases and respective exothermic phases are distinguished. As described above with reference to the first embodiment 100, the second valve 132 rations the flow of the hot combustion fluid, or of the flow of the mixture of the hot air and the hot combustion fluid, from the manifold 118 via the container 124 to the exhaust 128. The rationing is governed according to the instantaneous heat requirement of the processing of the substance in the retort 102. Similarly, the fifth valve 212 rations the flow of the hot combustion fluid, or of the flow of the mixture of the hot air and the hot combustion fluid, from the manifold 118 via the further container 204 to the exhaust 128. The rationing implemented by the fifth valve 212 is governed according to the instantaneous heat requirement of the processing of the substance in the further retort 202.

The settings of the second valve 132, the third valve 134, the fourth valve 138 and the fifth valve 212 can be used as specified in the schedule below in order to implement a control scenario for operating the retort 102 and the further retort 202. For all cases specified in the schedule below, the second valve 132 is set to ration the flow in the fifth pipe 130 according to the heat requirement of the retort 102, and the fifth valve 212 is set to ration the flow in the eleventh pipe 210 according to the heat requirement of the further retort 202.

| | Retort (202) endothermic | Retort (202) exothermic |
|---|---|---|
| | (energy lack = L202) | (energy surplus = S202) |
| Retort (102) | The third valve 134 is set to open a | If S202 < L102: |
| endothermic | passageway for the flow of air from the air | The third valve 134 is set to open a |
| (energy | supply 112 to the manifold 118 via the heat | passageway for the flow of air from the air |
| lack = | buffer 106, and to close the passageway to | supply 112 to the manifold 118 via the heat |
| L102) | the exhaust 128 via the eighth pipe 142. The | buffer 106, and to close the passageway to |
| | fourth valve 138 rations the flow of air and, | the exhaust 128 via the eighth pipe 142. The |
| | thereby, the amount of heat transferred by | fourth valve 138 rations the flow of air and, |
| | the heat buffer 106 to the air. | thereby, the amount of heat transferred by |
| | | the heat buffer 106 to the air. |
| | | If S202 > L102: |
| | | The third valve 134 is set to block the |
| | | passageway for the air from the air supply |
| | | 112 to the heat buffer 106. The third valve |
| | | 134 is set to open the passageway for the hot |
| | | combustion fluid from the combustor 104 to |
| | | the exhaust 128 via the heat buffer 106. |
| Retort (102) | If S102 < L202: | The third valve 134 blocks the flow of air from |
| exothermic | The third valve 134 is set to open a | the air supply 112, and opens the |
| (energy | passageway for the flow of air from the air | passageway for the combustion fluid from the |
| surplus = | supply 112 to the manifold 118 via the heat | combustor 104 to the exhaust 128 via the |
| S102) | buffer 106, and to close the passageway to | manifold 118 and the heat buffer 106. |
| | the exhaust 128 via the eighth pipe 142. The | |
| | fourth valve 138 rations the flow of air and, | |
| | thereby, the amount of heat transferred by | |
| | the heat buffer 106 to the air. | |
| | If S102 > L202: | |
| | The third valve 134 is set to block the | |
| | passageway for the air from the air supply | |
| | 112 to the heat buffer 106. The third valve | |
| | 134 is set to open the passageway for the hot | |
| | combustion fluid from the combustor 104 to | |
| | the exhaust 128 via heat buffer 106. | |

Note that the flow throughout the heat distribution system is controlled by the settings of the second valve 132, the third valve 134, the fourth valve 138 and the fifth valve 212. The following heat distribution scenarios can be implemented under control of these five valves:

1) transport of heat from the combustor 104 to the retort 102 by means of the combustion fluid;

2) transport of heat from the combustor 104 to the further retort 202 by means of the combustion fluid;

3) transport of heat from the combustor 104 to both the retort 102 and the further retort 202 by means of the combustion fluid;

4) transport of heat from the combustor 104 to the retort 102 and the heat buffer 106 by means of the combustion fluid;

5) transport of heat from the combustor 104 to the further retort 202 and the heat buffer 106 by means of the combustion fluid;

6) transport of heat from the combustor 104 to the retort 102, to the further retort 202 and to the heat buffer 106 by means of the combustion fluid;

7) transport of heat from the combustor 104 to the heat buffer 106 by means of the combustion fluid;

8) transport of heat from the heat buffer 106 to the retort 102;

9) transport of heat from the heat buffer 106 to the further retort 202

10) transport of heat from the heat buffer 106 to the retort 102 and to the further retort 202.

The manifold 118 used in above scenarios is a passive element interconnecting the second pipe 120, the third pipe 122, the fourth pipe 126 and the twelfth pipe 214.

Operating two retorts in counter-phase may result in a self-sustained and continual process, and the use of an additional heating fuel can be avoided entirely or at least minimized. The stringent condition of balancing the instantaneous heat generation with instantaneous heat consumption, does not apply. Neither is it a condition that the total of endothermic phases should last shorter than the total of exothermic phases. However, as in the case of a processing the substance with only a single retort, at least one condition should be fulfilled for maintaining a continual process that is self-sufficient in energy. This condition is that the heat of combustion of the total amount of process fluid produced equals at least the amount of energy required by the total of endothermic phases. If this condition is not satisfied, additional heating fuel is needed, however in such case its use in the processing system with two retorts can be minimized by making use of the invention.

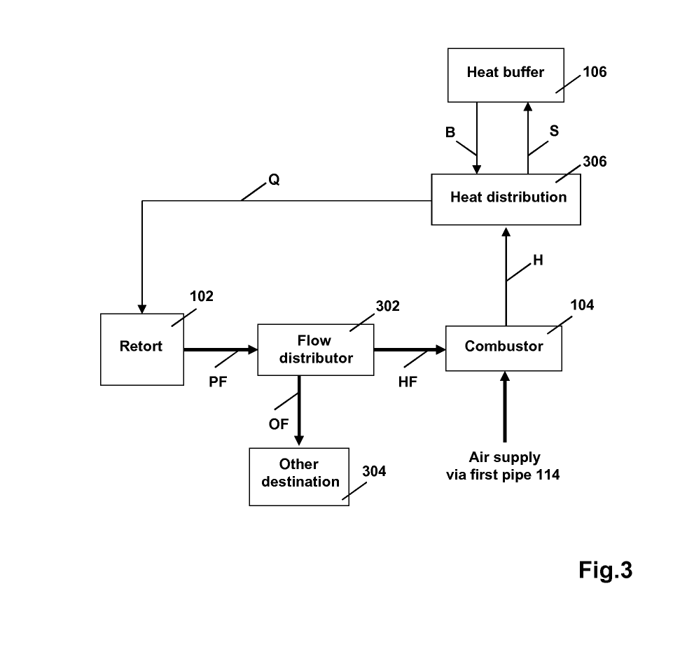

FIG. 3 is a block diagram of the first embodiment 100 of a processing system in the invention, for clarifying the control of the heat distribution between the retort 102 and the heat buffer 106, on the basis of the precise distinction between the endothermic phases and the exothermic phases of a retorting cycle. In the block diagram of FIG. 3, the bold arrows indicate the flow of material, the thin arrows indicate the flow of heat.

The processing of the substance in the retort 102 produces a flow PF of the combustible process fluid. The flow PF of the process fluid goes from the retort 102 to the flow distributor 302. A flow distributor 302 channels a part of the flow PF of the process fluid to the combustor 104, and another part of the flow PF of the process fluid to another destination 304 for further processing. The part of the process fluid that is used for combustion in the combustor 104 is defined above as the heating fluid. The flow of the process fluid that is channeled to the combustor 104 is herein referred to as the flow HF of the heating fluid. The flow HF of the heating fluid goes from the distributor 302 to the combustor 104. The flow of the other part of the process fluid to the other destination 304 is herein referred to as the flow OF. The flow OF of the process fluid goes from the distributor 302 to the other destination 304. Instead of using the flow distributor 302 for dividing the flow PF of the process fluid, one could just channel all of the process fluid, released by the substance in the retort 102, to the combustor 104.

In the combustor 104, the heating fluid is combusted with air that is supplied via the first pipe 114. The combustion of the heating fluid produces a flow of a combustion fluid. The flow of the combustion fluid represents a flow H of combustion heat. The flow H of the combustion fluid goes from the combustor 104 to the heat distribution system 306. The physical dimension of the flow H of combustion heat is “Joule/second”. The flow H of the combustion heat is proportional to a product of the mass flow of the heating fluid and the calorific value CV of the heating fluid. The flow HF of the heating fluid has the physical dimension “kg/second”. The calorific value CV of the heating fluid has the physical dimension “Joule/kg”.

The flow H of the combustion heat can be used to heat up the heat buffer 106 and/or to supply heat to the retort 102. Heat is supplied to the retort 102 under control of the instantaneous heat requirement Q of the retort 102. The instantaneous heat requirement Q has the physical dimension “Joule/second”.

If the flow H of the combustion heat is larger than the instantaneous heat requirement Q, surplus heat is available for storage in the heat buffer 106. A flow S of the surplus heat goes then from the heat distribution system 306 to the heat buffer 106. The magnitude of the flow S is then the difference between the flow H and the instantaneous heat requirement Q.

If the flow H of the combustion heat is smaller than the instantaneous heat requirement Q, supplementary heat is required by the retort 102. The supplementary heat is provided by the heat buffer 106. As the supplementary heat, part of the heat is used that is stored in the heat buffer 106. In this case, a flow B of the buffered heat goes from the heat buffer 106 to the heat distribution system 306. The magnitude of the flow B is the difference between the instantaneous heat requirement Q and the flow H.

The processing of the substance in the retort 102 is in an endothermic phase if the instantaneous heat requirement Q exceeds the flow H of the combustion heat. The processing of the substance in the retort 102 is in an exothermic phase, if the instantaneous heat requirement Q is lower than the flow H of the combustion heat.

Each of the flow PF of the process fluid, the flow HF of the heating fluid, the flow H of the combustion heat, the flow S of the surplus heat, the instantaneous heat requirement Q, and the calorific value CV may vary with time during the processing of the substance in the retort 102.

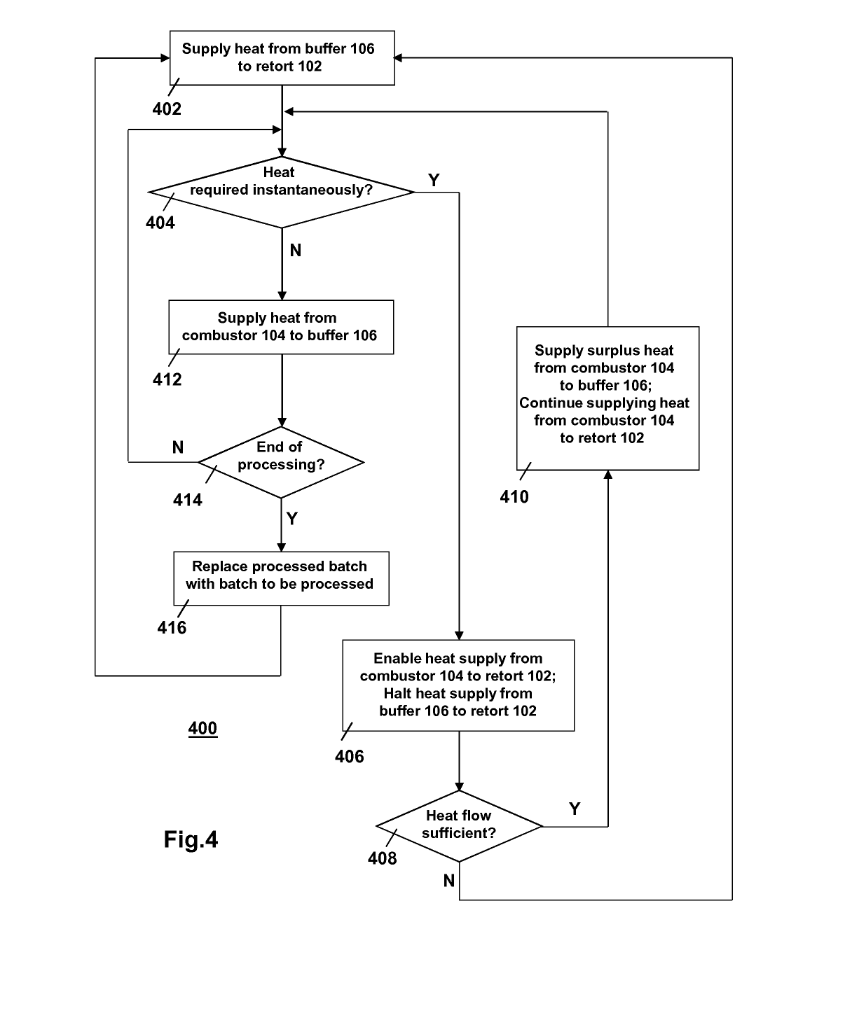

FIG. 4 is a flow diagram illustrating a method 400 according to the invention applied in, e.g., the first embodiment 100 of the processing system. Assume that a batch of a substance to be processed has been placed into the retort 102 and that the first embodiment 100 is ready for operational use.

In a first step 402, the processing of the substance in the retort 102 is started by supplying heat from the heat buffer 106 to the retort 102. Throughout the execution of the method 400, the first valve 116 between the air supply 112 and the combustor 104, is controlled in dependence on the rate at which the heating fluid is being released by the substance in the retort 102. Controlling the first valve 116 in this manner ensures a good combustion of the heating fluid. The heating fluid may be released at any moment during the processing. The release is independent of whether the processing of the substance in the retort 102 is in an endothermic phase or in an exothermic phase, as explained above. The heating fluid may be released even at the start-up of the processing. The processing of the substance in the retort 102 starts in the endothermic phase.

At start-up, the valve settings of the heat distribution system are as follows.

The third valve 134, i.e., the three-way valve 134, is set to open a passageway for the flow of air from the air supply 112 to the manifold 118 via the heat-buffer 106, and to close the passageway for gas from the heat buffer 106 to the exhaust 128.

The second valve 132, between the retort 102 and the exhaust 128, is set to ration the gas flow in the fifth pipe 130 according to the heat requirement of the retort 102. The heat required is provided by the combustion fluid from the combustor 104 via the second pipe 120, and is supplemented by heated air from the heat buffer 106 via the third pipe 122. The flow of the heated air from the heat buffer 106, representing the heat supplement, is controlled by the setting of the fourth valve 138, which rations the flow of air through the heat buffer 106.

In a second step 404, it is determined whether or not the retort 102 needs to be heated. The second step 404 is implemented, for example, by monitoring a physical parameter indicative of the progress of the processing, e.g., the temperature of the retort 102 or the temporal behavior of the temperature of the retort 102, as discussed above. If it is determined that the retort 102 needs to be heated, the method 400 proceeds with a third step 406.

In the third step 406, the heat supply of the combustion fluid from the combustor 104 to the retort 102 is enabled, and the heat supply from the heat buffer 106 is halted. The control system applies the following valve settings. The second valve 132, in the fifth pipe 130 between the retort 102 and the exhaust 128, is set to ration the flow according to the heat requirement of the retort 102. The fourth valve 138, which is located between the air supply 112 and the third (three-way) valve 134 and which rations the flow of air, is closed. This is done to halt a heat provision from the heat buffer 106 to the retort 102, while maintaining a heat supply from the combustion fluid to the retort 102.

The reason for halting the heat provision from the heat buffer 106 to the retort 102 is to enable an analysis as to whether the processing in the retort 102 is in an endothermic phase or in an exothermic phase. If it has been determined in the second step 404 that the retort 102 needs to be heated, it is still undetermined whether the processing in the retort 102 is in an exothermic phase or in an endothermic phase. And, hence, it is yet uncertain how to operate the heat buffer 106, either for storing surplus heat or for supplying heat to the retort 102. Note that there may exist various subroutines to enable the assessment of whether the processing of the substance in the retort 102 is in an endothermic phase or in an exothermic phase.

In a next, fourth step 408, the assessment is carried out of whether the processing of the substance in the retort 102 is in an endothermic phase or in an exothermic phase. For example, it is determined in the fourth step 408 whether or not the heat flow of the combustion fluid from the combustor 104 to the retort 102 is sufficient for sustaining the processing. The fourth step 408 is implemented, for example, by monitoring the temperature of the retort 102 or the temporal behavior of the temperature of the retort 102. If the retort 102 requires more heat than is supplied in the third step 406, then the processing of the substance in the retort 102 is in an endothermic phase, and the method 400 returns from the fourth step 408 to the first step 402. If it is determined in the fourth step 408 that the processing of the substance in the retort 102 has reached an exothermic phase, there is a surplus of heat available from the flow of the combustion fluid produced by the combustor 104, although the retort 102 may still need to be heated. The method 400 then proceeds with a fifth step 410.

In the fifth step 410, the retort 102 continues to be heated by the flow of heat via the combustion fluid from combustor 104. The surplus heat, i.e., the part of the heat generated by the combustor 104 and not needed for the supply of heat to the retort 102, is supplied to the heat buffer 106 under control of the control system. To this end, the valve settings of the heat distribution system are as follows. The third valve 134, i.e., the three-way valve 134, is set to open a passageway for the flow of the combustion fluid from the combustor 104, via the manifold 118 and via the heat-buffer 106 to the exhaust 128. The third valve 134 closes the passageway for air from the air supply 112 to the heat buffer 106. The second valve 132, between the retort 102 and the exhaust 128, is set to ration the flow in the fifth pipe 130 according to the heat requirement of the retort 102. The heat is provided to the retort 102 solely by the combustion fluid flowing from the combustor 104 to the retort 102 via the second pipe 120, the manifold 118 and the fourth pipe 126. The method 400 returns from the fifth step 410 to the second step 404.

The third step 406, the fourth step 408 and the fifth step 410 discussed above follow the decision taken in the second step 404 that the retort 102 instantaneously requires a supply of heat. If it is determined in the second step 404 that the retort 102 does not need to be heated, the processing in the retort 102 is in an exothermic phase, and the method proceeds with a sixth step 412.

In the sixth step 412, the control system channels the flow of the combustion fluid entirely to the heat buffer 106, as the processing of the substance in the retort 102 is in an exothermic phase. The valve settings are then as follows. The third valve 134, i.e., the three-way valve 134, is set to open a passageway for the combustion fluid from the combustor 104 to the exhaust 128 via the manifold 118 and the heat buffer 106. The third valve 134 also closes the passageway for the air from the air supply 112 to the heat buffer 106. The second valve between the retort 102 and the exhaust 128 is closed.

Following the sixth step 412, it is determined in a seventh step 414 whether or not the processing of the substance in the retort 102 has ended. This determining is implemented, for example, by monitoring the release rate of the process fluid through monitoring the oxygen concentration and/or the carbon monoxide concentration in the combustion fluid, in combination with controlling the supply of air from the air supply 112 to the combustor 104. If the release rate of the process fluid has dropped below a pre-determined threshold, it is assumed that the processing has ended. The method 400 proceeds than with an eighth step 416.

In the eighth step 416, the retort 102 is emptied and the processed substance is removed. The retort 102 is then filled with a next batch of the substance to be processed. Alternatively, the current retort 102 is removed from the embodiment 100 and replaced by another retort 102 filled with the next batch of the substance to be processed. Thereupon, the method 400 returns to the first step 402.

If it is determined in the seventh step 414 that the processing of the substance in the retort 102 has not ended, the method 400 returns to the second step 404.

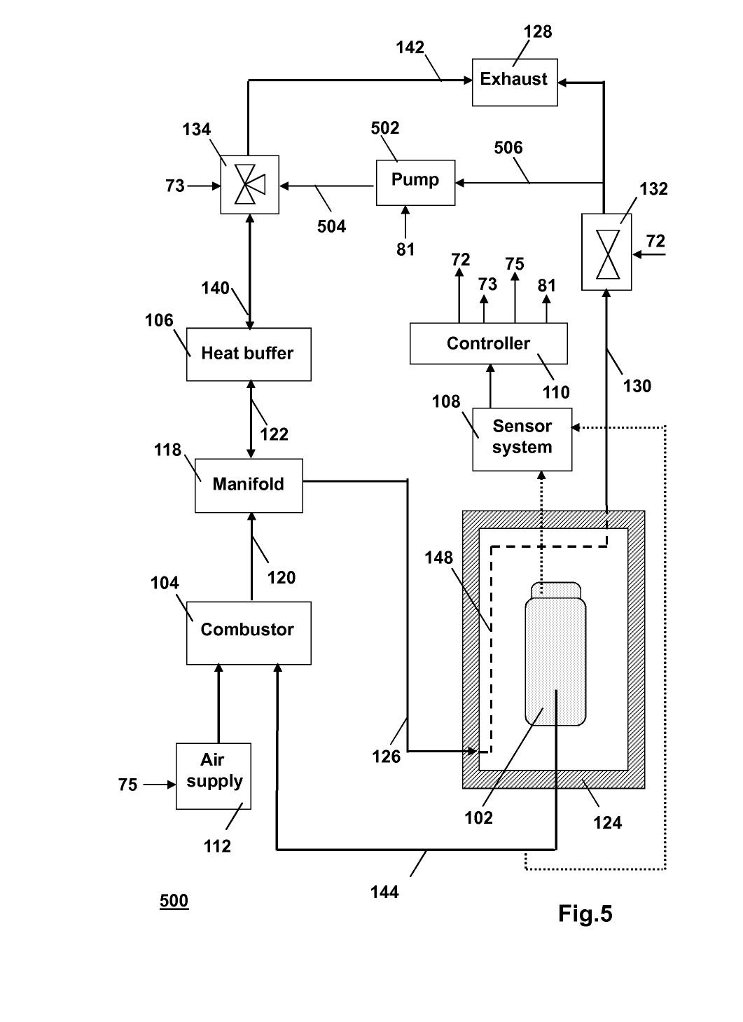

FIG. 5 is a diagram of a third embodiment 500 of a processing system for processing a substance according to the invention, and is a variation on the theme illustrated in the diagram of FIG. 1. A first difference between the first embodiment 100 and the third embodiment 500 is that the wall 146 is absent from this third embodiment 500. A second difference between the first embodiment 100 and the third embodiment 500 is the selection of the reclaiming fluid that is used to take up part of the stored heat from the heat buffer 106 and transport the part of the stored heat taken up to the retort 102. In the first embodiment 100, the reclaiming fluid is air, whereas in the third embodiment 500 the reclaiming fluid is a proportion of the fluid that has arrived in the fifth pipe 130. A fluid circulation pump 502 enables to use a proportion of the fluid that has arrived in the fifth pipe 130 as the reclaiming fluid. The fluid circulation pump 502 is controlled via a seventh control signal 81 supplied by the controller 118. The fluid circulation pump 502 is connected to the third valve 134 via a thirteenth pipe 504, and through a fourteenth pipe 506 to a junction between the second valve 132 and the exhaust 128.

Note that the first difference and the second difference are independent of each other: the first difference can be implemented without implementing the second difference and vice versa. Operation of the third embodiment 500 is as follows.

Consider the third embodiment 500 at an exothermic processing phase, wherein the substance in the retort 102 releases a combustible process fluid, and wherein not all of the energy contained in the combustible process fluid is needed by the retort 102 to sustain the processing. The process fluid is, at least partly, supplied via the ninth pipe 144 to the combustor 104. Also, air is supplied from the air supply 112 to the combustor 104 under control of the fifth control signal 75 in order to regulate the combustion of the process fluid at the combustor 104. Under control of the second control signal 72, the second valve 132 is set to control the combustion fluid to flow only partly into the fourth pipe 126 and further through the passageway 148 and the fifth pipe 130 to the exhaust 128. The three-way valve 134 is set, via the third control signal 73 into a state, wherein the flow from the seventh pipe 140 into the thirteenth pipe 504 is blocked, and a flow from the seventh pipe 140 to the eighth pipe 142 is opened. As a result, a proportion of the combustion fluid passes through the heat buffer 106, where that proportion of the combustion fluid gives off its sensible heat for storage at the heat buffer 106 and cools-down. The cooled-down proportion of the combustion fluid passes through the eighth pipe 142 to the exhaust 128.

Now consider an endothermic phase of the processing of the substance in the retort 102, wherein stored heat in the heat buffer 106 is used to supply heat to the retort 102 in the container 124. For this purpose, the three-way valve 134 is set, via the third control signal 73 into a state wherein a flow from the thirteenth pipe 504 to the eighth pipe 142 is blocked and a flow from the thirteenth pipe 504 to the seventh pipe 140 is enabled, and the second valve 132 is opened under control of the second control signal 72, to enable a flow into the fourth pipe 126 and further through the passageway 148 to the fifth pipe 130. Fluid that has arrived in the fifth pipe 130 has given off heat to the retort 102 and, therefore, has been cooled. Under control of the seventh control signal 81, the fluid circulation pump 502 pumps at least part of the cooled fluid from the fifth pipe 130 through the heat buffer 106, to take up at least part of the stored heat. This part of the fluid taken from the fifth pipe 130 is the reclaiming fluid. The reclaiming fluid is heated by the heat buffer 106, and in the manifold 118 the reclaiming fluid is mixed with combustion fluid, if any, from the combustor 104. From the manifold 118, the mixture of the combustion fluid and the reclaiming fluid passes to the container 124 where the mixture transfers heat to the retort 102 and cools down. This mixture is an example of the conveying fluid, as defined above. If, during this endothermic processing phase, a combustion fluid is released from the combustor 104, the mixed flow of the combustion fluid and the reclaiming fluid is larger than the flow of the reclaiming fluid, and the increment is a fluid mixture that is released from the system through the exhaust 128. Whether or not an over-pressure relief valve is needed between the fluid circulation pump 502 and the exhaust 128 is dependent upon prevailing pressures and is left to the judgment of the person skilled in the art.

A reason for using the cooled fluid from the fifth pipe 130 as the reclaiming fluid is the potentially high contents of water vapor and carbon dioxide in this fluid. These compounds are known for their good emissivity, a property of which advantage can be taken in the transfer of heat from the mixture of the combustion fluid and the reclaiming fluid, i.e., from the conveying fluid, to the retort 102.

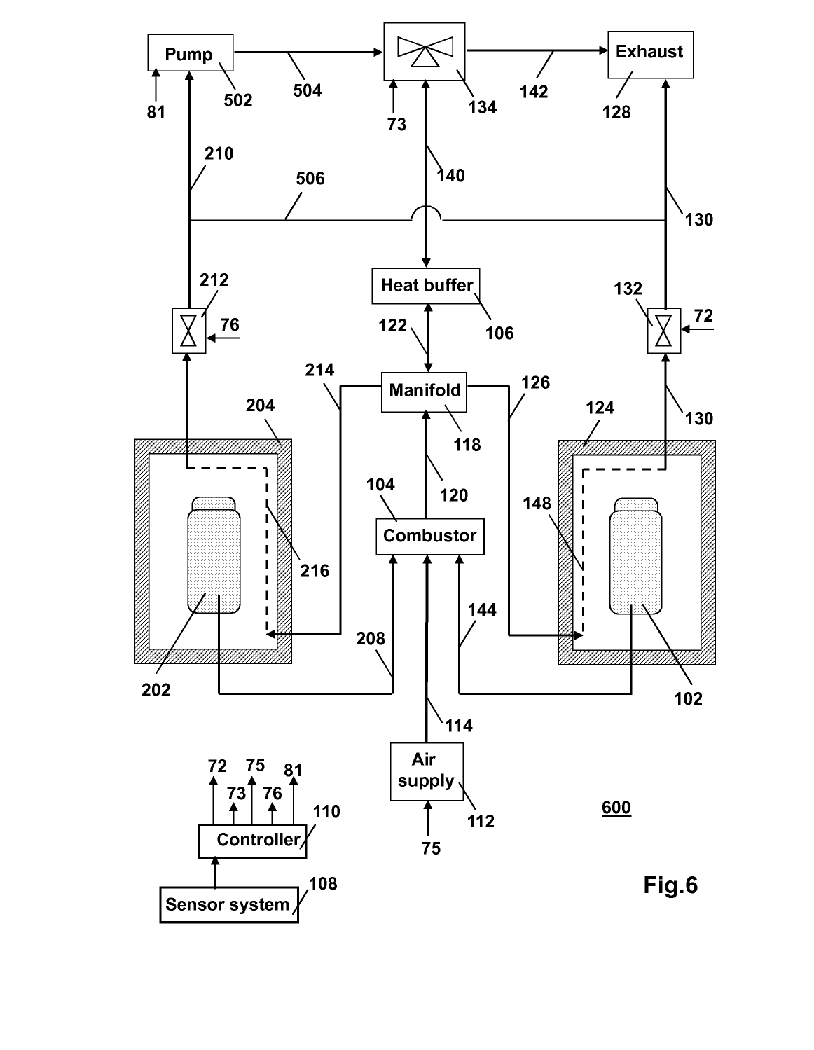

FIG. 6 is a diagram of a fourth embodiment 600 of a processing system for processing a substance according to the invention, and is a variation on the theme illustrated in the diagram of FIG. 2. A first difference between the second embodiment 200 and the fourth embodiment 600 is that the wall 146 and the wall 206 are absent from this fourth embodiment 600. A second difference between the second embodiment 200 and the fourth embodiment 600 is the selection of the reclaiming fluid that is used to take up part of the stored heat from the heat buffer 106 and transport the heat taken up to the retort 102 and to the further retort 202. In the second embodiment 200, the reclaiming fluid is air, whereas in the fourth embodiment 600 the reclaiming fluid is part of the fluid that has arrived in the fifth pipe 130 or in the eleventh pipe 210, or a mixture thereof. A reason for using this fluid as the reclaiming fluid is the potentially high contents of water vapor and carbon dioxide in this fluid. These compounds are known for their good emissivity, a property of which advantage can be taken in the transfer of heat to the retort 102 and to the further retort 202. The fluid circulation pump 502 enables the use of a proportion of the fluid that has arrived in the fifth pipe 130 and/or in the eleventh pipe 210 as the reclaiming fluid. The fluid circulation pump 502 is controlled via the seventh control signal 81 supplied by the controller 118. The fluid circulation pump 502 is connected via the thirteenth pipe 504 to the third valve 134, via the fourteenth pipe 506 to the fifth pipe 130 at a junction between the second valve 132 and the exhaust 128, via the eleventh pipe 210 to the fifth valve 212.

Note that the two differences of second embodiments 200 and the fourth 600 are independent of each other: the first difference can be implemented without implementing the second difference and vice versa. Operation of the fourth embodiment 600 is as follows.

The heat buffer 106 is being filled with heat whenever there is a surplus of heat available in the combustion fluid released by the combustor 104, by setting the second valve 132 and the fifth valve 212 under control of the second control signal 72 and the sixth control signal 76, respectively (based on the heat requirements of each individual one of the retort 102 and the further retort 202), and by setting the third valve 134 under control of the third control signal 73 in such a way, that a flow from the seventh pipe 140 to the eighth pipe 142 is enabled and a flow from the seventh pipe 140 to the thirteenth pipe 504 towards the fluid circulation pump 502 is blocked. Stored heat from the heat buffer 106 is made available to any of the retort 102 and the further retort 202, or to both the retort 102 and the further retort 202 together, as follows. The conveying fluid of the fourth embodiment 600 has given off heat to at least one the retort 102 and the further retort 202 and, therefore, has been cooled. Under control of the seventh control signal 81, the fluid circulation pump 502 pumps at least part of the cooled conveying fluid, that has now adopted the function of the reclaiming fluid, through the heat buffer 106, to take up at least part of the stored heat. The seventh control signal 81 activates the fluid circulation pump 502 if at least one of the retorts 102 and the further retort 202 is in an endothermic processing phase and if neither the retort 102 nor the further retort 202 is in an exothermic processing state to such an extent that it can provide for the combined energy needs of the retort 102 and the further retort 202 together. The second valve 132 and the fifth valve 212 are set under control of the second control signal 72 and the sixth control signal 76, respectively (based on the heat requirements of each of the two retorts), and the third valve 134 is set under control of the third control signal 73 in such a way, that a flow from the thirteenth pipe 504 to the seventh pipe 140 is enabled and a flow from the thirteenth pipe 504 to the eighth pipe 142 towards the exhaust 128 is blocked. The reclaiming fluid is heated by the heat buffer 106, and the reclaiming fluid is mixed in the manifold 118 with the combustion fluid from the combustor 104, if any combustion fluid is available. This mixture adopts the role of the conveying fluid, as defined above. From the manifold 118, the mixture of the combustion fluid and the reclaiming fluid flows to the container 124 and the further container 204 to an extent determined by the settings of the second valve 132 and of the fifth valve 212 (under control of the second control signal 72 and of the sixth control signal 76, based on the respective heat requirements of each individual one of the retort 102 and the further retort 202), where the mixed fluid transfers heat to the retort 102 and/or to the further retort 202, and cools down. If during this processing phase a combustion fluid is released from the combustor 104, the mixed flow of the reclaiming fluid and the combustion fluid is larger than the flow of the reclaiming fluid alone, and the increment is a fluid mixture that is released from the system through the exhaust 128. Whether or not an over-pressure relief valve is needed between the fluid circulation pump 502 and the exhaust 128 is dependent upon prevailing pressures and left to the judgment of the person skilled in the art.

1. A processing system (100; 200) for processing a substance, wherein:
the processing system is configured for processing the substance in subsequent batches;
the substance releases a combustible process fluid during the processing;
the processing system comprises:
a batch-wise operated retort (102; 202), configured for processing the substance a single batch at a time;
a combustor (104), connected to the retort for receiving at least a part of the process fluid released by the substance in the retort, and operative to combust the received part of the process fluid for generating heat;
temporary heat storage (106) for temporarily storing buffered heat;
a heat distribution system (118, 120, 122, 126, 132, 134,) coupled to the combustor, the temporary heat storage and to the retort and configured to distribute the generated heat between the temporary heat storage and the retort, and to supply the buffered heat to the retort; and
a control system (110) configured for controlling the heat distribution system for:
supplying (406) the generated heat to the retort under control of an instantaneous heat requirement of the processing of the substance in the retort;
supplying (402) at least part of the buffered heat to the retort under control of the instantaneous heat requirement; and
increasing the buffered heat by storing (410) in the temporary heat storage at least another part of the generated heat if the other part of the generated heat exceeds the instantaneous heat requirement.

2. The processing system of claim 1, wherein:
the control system comprises a sensor system (108) for sensing a physical parameter, representative of the instantaneous heat requirement, and for supplying a sensor signal representative of the physical parameter;
the control system comprises a controller (110) that is configured for receipt of the sensor signal, and for generating a control signal for control of the heat distribution system in dependence on the sensor signal received.

3. The processing system of claim 1, wherein the control system is configured for manual control of the heat distribution system.

4. The processing system of claim 1, wherein:
the combustor produces a combustion fluid as a result of combusting the received part of the process fluid for generating heat;
the heat distribution system is configured for selectively:
transferring at least part of the generated heat to the temporary heat storage by means of channeling at least part of the combustion fluid from the combustor to the temporary heat storage;
reclaiming at least part of the buffered heat by means of channeling a reclaiming fluid via the temporary heat storage; and
heating the retort by means of channeling to the retort a conveying fluid that comprises at least one of: the reclaiming fluid and at least a part of the combustion fluid.

5. The processing system of claim 4, wherein the reclaiming fluid comprises at least part of the conveying fluid after the conveying fluid has heated the retort.

6. The processing system of claim 1, wherein:
the processing system comprises a batch-wise operated further retort (202), configured for processing a further substance a further single batch at a time;
the processing of the further substance in the further retort releases a combustible further process fluid;
the combustor is connected to the further retort for receiving at least a further part of the further process fluid released by the further substance in the further retort; and
the combustor is operative to combust the received further part of the further process fluid for generating further heat;
the heat distribution system is coupled to the further retort; and
the heat distribution system is configured for distributing the generated heat and the generated further heat between the temporary heat storage, the retort and the further retort, and for distributing the buffered heat between the retort and the further retort
the control system (110) is configured for controlling the heat distribution system for:
supplying at least one of the generated heat and the generated further heat to the retort under control of the instantaneous heat requirement;
supplying at least one of the generated heat and the generated further heat to the further retort under control of a further instantaneous heat requirement of the processing of the further substance in the further retort;
supplying at least part of the buffered heat to the further retort under control of the further instantaneous heat requirement; and
increasing the buffered heat by storing in the temporary heat storage at least a further part of the generated further heat if the further part exceeds at least one of the instantaneous heat requirement and the further instantaneous heat requirement.

7. The processing system of claim 6, wherein:
the control system comprises a sensor system (108) for sensing a physical parameter, representative of an instantaneous heat requirement of the processing of the substance in the retort, and for sensing a further physical parameter, representative of a further instantaneous heat requirement of the processing of the further substance in the further retort, and for supplying a sensor signal representative of the physical parameter and a further sensor signal representative of the further physical parameter;
the control system comprises a controller (110) that is configured for receipt of the sensor signal and the further sensor signal, and for generating a control signal for control of the heat distribution system in dependence on the sensor signal received and the further sensor signal received.

8. The processing system of claim 6, configured for the processing of the substance in the retort in one of: an endothermic phase and an exothermic phase when the processing of the further substance in the further retort is in the other one of the endothermic phase and the exothermic phase.

9. The processing system of claim 1, wherein the substance comprises a biomass and wherein the processing comprises at least one of: making of charcoal by the processing of the biomass; making of a liquid distillation product by the processing of the biomass; and making of a gaseous distillation product by the processing of the biomass.

10. A method (400) of processing a substance in subsequent batches, wherein:
the substance releases a combustible process fluid during the processing;
the method comprises:
using a batch-wise operated retort (102; 202), configured for processing the substance a single batch at a time;
receiving at least part of the combustible process fluid released by the substance in the retort;
combusting the received part of the process fluid for generating heat in a combustor (104);
using temporary heat storage (106) for temporarily storing buffered heat; and
controlling the processing;
the controlling comprises:
determining an instantaneous heat requirement of the processing of the substance in the retort:
supplying at least part of the generated heat to the retort under control of the instantaneous heat requirement;
supplying at least part of the buffered heat to the retort under control of the instantaneous heat requirement; and
increasing the buffered heat by storing in the temporary heat storage at least another part of the generated heat if the other part of the generated heat exceeds the instantaneous heat requirement.

11. The method of claim 10, wherein:
the determining of the instantaneous heat requirement comprises sensing a physical parameter, representative of the instantaneous heat requirement; and
the supplying of the at least part of the generated heat, the supplying of the at least part of the buffered heat, and the increasing of the buffered heat are controlled in dependence on the sensing.

12. The method of claim 10, wherein:
the combusting produces a combustion fluid as a result of combusting the received part of the process fluid for generating heat;
the controlling comprises:
selectively transferring at least part of the generated heat to the temporary heat storage by means of channeling at least part of the combustion fluid from the combustor to the temporary heat storage;
selectively reclaiming at least part of the buffered heat by means of channeling a reclaiming fluid via the temporary heat storage; and
selectively heating the retort by means of channeling to the retort a conveying fluid that comprises at least one of: the reclaiming fluid and at least a part of the combustion fluid.

13. The method of claim 12, wherein the reclaiming fluid comprises at least part of the conveying fluid after the conveying fluid has heated the retort.

14. The method of claim 10, wherein:
the method comprises using a batch-wise operated further retort (202), configured for processing a further substance a further single batch at a time;
the processing of the further substance in the further retort releases a combustible further process fluid;
receiving at least a further part of the further process fluid released by the further substance in the retort; and
combusting the received further part of the further process fluid for generating further heat;
the method comprises:
distributing the generated heat and the generated further heat between the temporary heat storage, the retort and the further retort, and distributing the buffered heat between the retort and the further retort;
determining a further instantaneous heat requirement of the processing of the further substance in the further retort; and
controlling the distributing for:
supplying at least one of the generated heat and the generated further heat to the retort under control of the instantaneous heat requirement;
supplying at least one of the generated heat and the generated further heat to the further retort under control of the further instantaneous heat requirement;
supplying at least part of the buffered heat to the further retort under control of the further instantaneous heat requirement; and
increasing the buffered heat by storing in the temporary heat storage at least a further part of the generated further heat if the further part exceeds at least one of the instantaneous heat requirement and the further instantaneous heat requirement.

15. The method of claim 14, wherein:
the controlling comprises sensing a physical parameter, representative of the instantaneous heat requirement of the processing of the substance in the retort, and sensing a further physical parameter, representative of the further instantaneous heat requirement;
the supplying of at least one of the generated heat and the generated further heat to the retort, the supplying of at least one of the generated heat and the generated further heat to the further retort, the supplying of at least part of the buffered heat to the further retort, and the increasing of the buffered heat by storing in the temporary heat storage at least a further part of the generated further heat are controlled in dependence on the sensing.

16. The method of claim 14, wherein the controlling is configured for the processing of the substance in the retort in one of: an endothermic phase and an exothermic phase when the processing of the further substance in the further retort is in the other one of the endothermic phase and the exothermic phase.

17. The method of claim 10, wherein the substance comprises a biomass and wherein the processing comprises at least one of: making of charcoal by the processing of the biomass; making of a liquid distillation product by the processing of the biomass; and making of a gaseous distillation product by the processing of the biomass.
